(19) United States
(12) Patent Application Publication
(10) Pub. No.: US 2007/0271421 A1
(43) Pub. Date: Nov. 22, 2007

(54) Reducing aging effect on memory

(76) Inventors: Nam Sung Kim, Portland, OR (US); Shih-Lien L. Lu, Portland, OR (US); Chris Wilkerson, Portland, OR (US); Edward Grochowski, San Jose, CA (US)

Correspondence Address: Caven & Aghevli LLC;PortfolioIP, P.O. Box 52050, Minneapolis, MN, 55402, US

(21) Appl. No.: 11/435,701

(22) Filed: May 17, 2006

(51) Int. Cl. G06F 13/00

(52) U.S. Cl. 711/154

(57) ABSTRACT

Methods and apparatus to reduce aging effect on memory are described. In one embodiment, a modified version of data is stored in a portion of a storage unit during a first time period.

### BACKGROUND

The present disclosure generally relates to the field of electronics. More particularly, an embodiment of the invention relates to reducing aging effect on memory.

As integrated circuit fabrication technology improves, semiconductor manufacturers are able to integrate additional functionality onto a single silicon substrate. As the number of these functionalities increases, however, so does the number of components on a single chip. Additional components may increase signal switching, in turn, generating more heat. The additional heat may damage various components of a chip. For example, memory devices that utilize p-channel metal-oxide semiconductor (P-MOS) transistors may be affected by the additional heat when the transistors are negatively biased over time, e.g., due to negative bias temperature instability (NBTI). Oxide degradation may also damage the transistors over time.

As memory devices degrade, their read or write stability may suffer, for example, due to shift in their gate threshold voltage. Designs may include margins to reduce the impact by such degradations, but the additional design margins may reduce performance and/or increase the requisite area to provide memory devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 7, and 8 illustrate block diagrams of embodiments of computing systems, which may be utilized to implement various embodiments discussed herein.

FIG. 2 illustrates a block diagram of portions of a processor core, according to an embodiment of the invention.

FIG. 3 illustrates a block diagram of portions of a cache, according to an embodiment of the invention.

FIGS. 4 and 5 illustrate block diagrams of storage systems, according to various embodiments.

FIG. 6 illustrates a flow diagram of an embodiment of a method to modify one or more bits of data stored in and/or read from a storage unit, in accordance with an embodiment of the invention.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

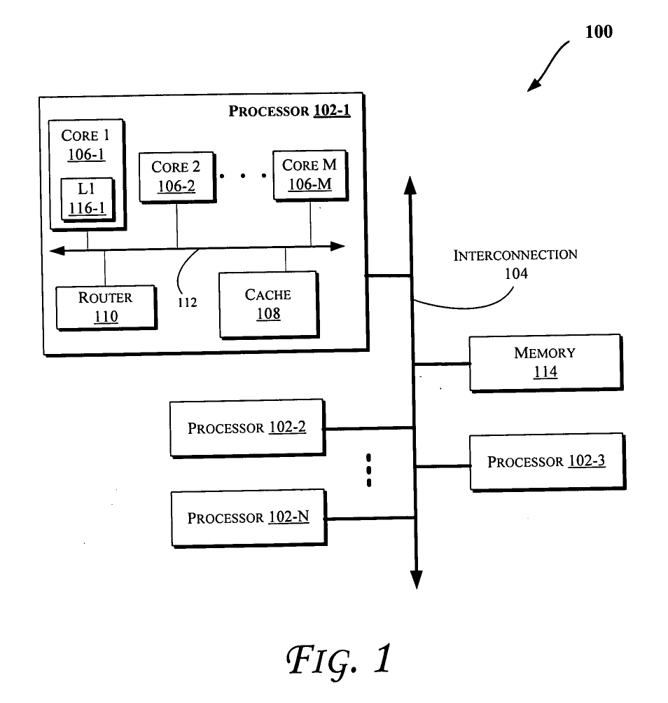

Some of the embodiments discussed herein may provide efficient mechanisms for reducing aging effect on memory (for example, due to NBTI and/or oxide degradation). In an embodiment, such effects may be reduced by periodically switching the voltage bias on the gates of cross-coupled transistors (which may form an inverter in an embodiment) that are utilized in memory devices, such as the memory devices discussed with reference to FIGS. 1-8. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

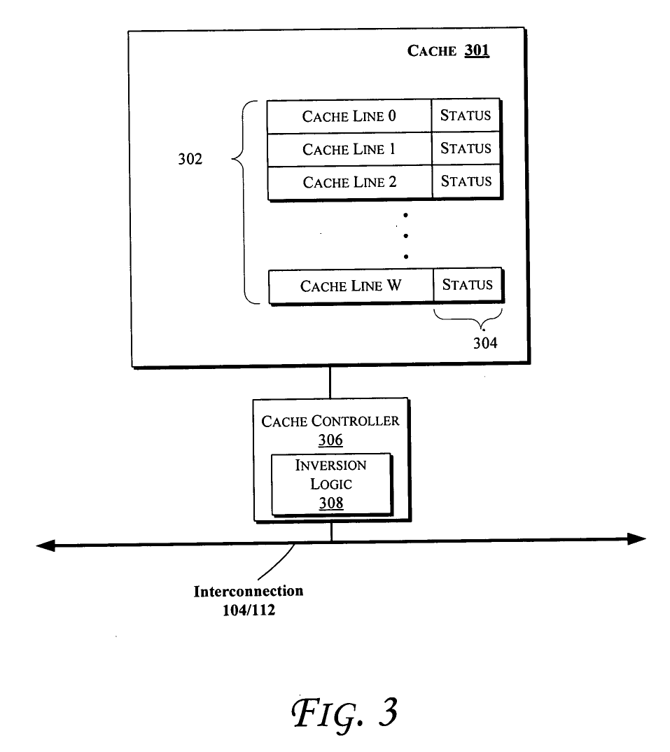

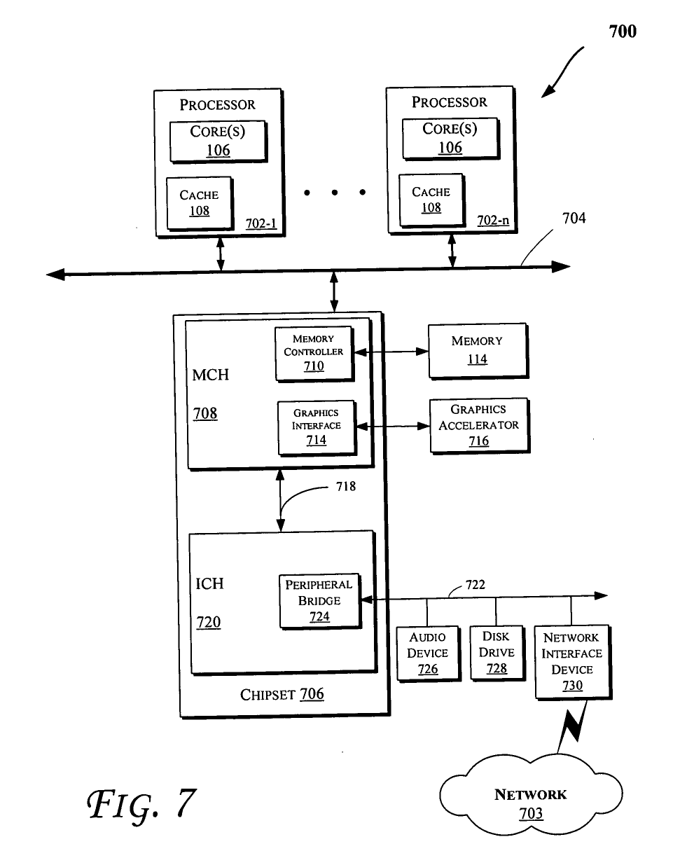

In an embodiment, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), memory controllers (such as those discussed with reference to FIGS. 3 and 7), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102. As shown in FIG. 1, the memory 114 may be in communication with the processors 102 via the interconnection 104. In an embodiment, the cache 108 (that may be shared) may have various levels, for example, the cache 108 may be a mid-level cache and/or a last-level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

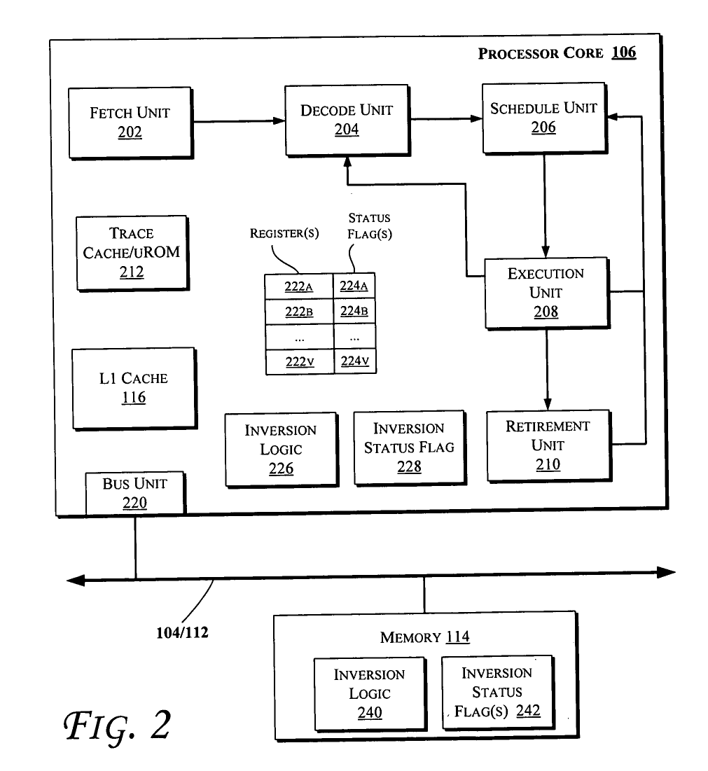

FIG. 2 illustrates a block diagram of portions of a processor core 106, according to an embodiment of the invention. In one embodiment, the arrows shown in FIG. 2 illustrate the flow direction of instructions through the core 106. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 104 and/or 112 of FIG. 1), memory controllers, or other components.

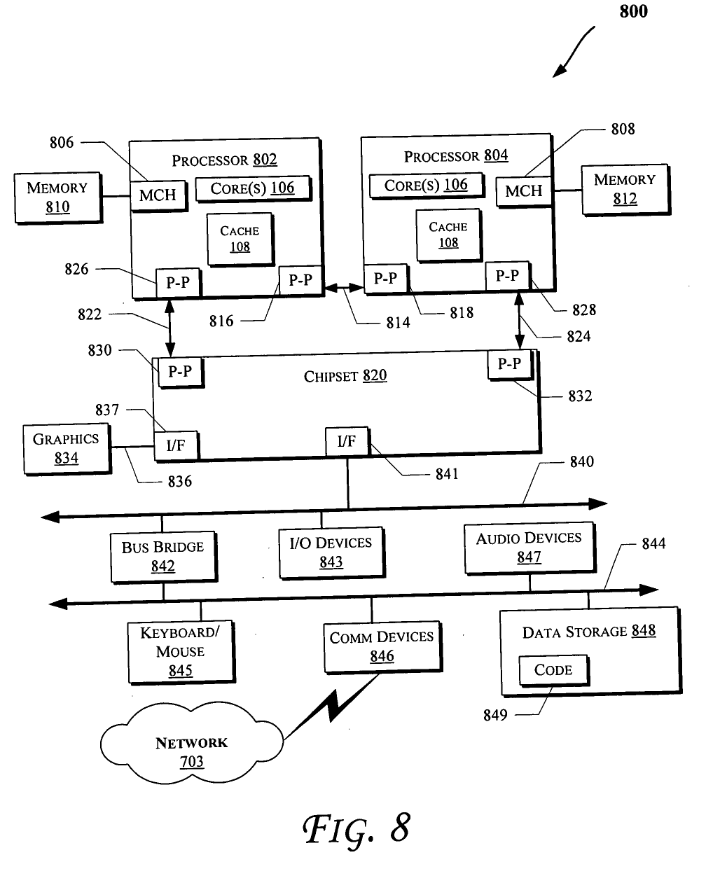

As illustrated in FIG. 2, the processor core 106 may include a fetch unit 202 to fetch instructions for execution by the core 106. The instructions may be fetched from any storage devices such as the memory 114 and/or the memory devices discussed with reference to FIGS. 7 and 8. The core 106 may also include a decode unit 204 to decode the fetched instruction. For instance, the decode unit 204 may decode the fetched instruction into a plurality of uops (micro-operations). Additionally, the core 106 may include a schedule unit 206. The schedule unit 206 may perform various operations associated with storing decoded instructions (e.g., received from the decode unit 204) until the instructions are ready for dispatch, e.g., until all source values of a decoded instruction become available. In one embodiment, the schedule unit 206 may schedule and/or issue (or dispatch) decoded instructions to an execution unit 208 for execution. The execution unit 208 may execute the dispatched instructions after they are decoded (e.g., by the decode unit 204) and dispatched (e.g., by the schedule unit 206). In an embodiment, the execution unit 208 may include more than one execution unit, such as a memory execution unit, an integer execution unit, a floating-point execution unit, or other execution units. The execution unit 208 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 208.

Further, the execution unit 208 may execute instructions out-of-order. Hence, the processor core 106 may be an out-of-order processor core in one embodiment. The core 106 may also include a retirement unit 210. The retirement unit 210 may retire executed instructions after they are committed. In an embodiment, retirement of the executed instructions may result in processor state being committed from the execution of the instructions, physical registers used by the instructions being de-allocated, etc.

The core 106 may additionally include a trace cache or microcode read-only memory (uROM) 212 to store microcode and/or traces of instructions that have been fetched (e.g., by the fetch unit 202). The microcode stored in the uROM 212 may be used to configure various hardware components of the core 106. In an embodiment, the microcode stored in the uROM 212 may be loaded from another component in communication with the processor core 106, such as a computer-readable medium or other storage device discussed with reference to FIGS. 7 and 8. The core 106 may also include a bus unit 220 to allow communication between components of the processor core 106 and other components (such as the components discussed with reference to FIG. 1) via one or more buses (e.g., buses 104 and/or 112). The core 106 may include one or more registers 222A through 222V (generally referred to herein as “register 222” or “registers 222”) to store various types of data discussed herein. In an embodiment, the registers 222 may be provided as variables stored in the cache 116. Also, each register 222 may have a corresponding inversion status flag 224 (which may be a single bit in an embodiment). For example, status flags 224A through 224V may respectively correspond to registers 222A through 222V. Also, each status flag 224 may correspond to a portion of one of the registers 222.

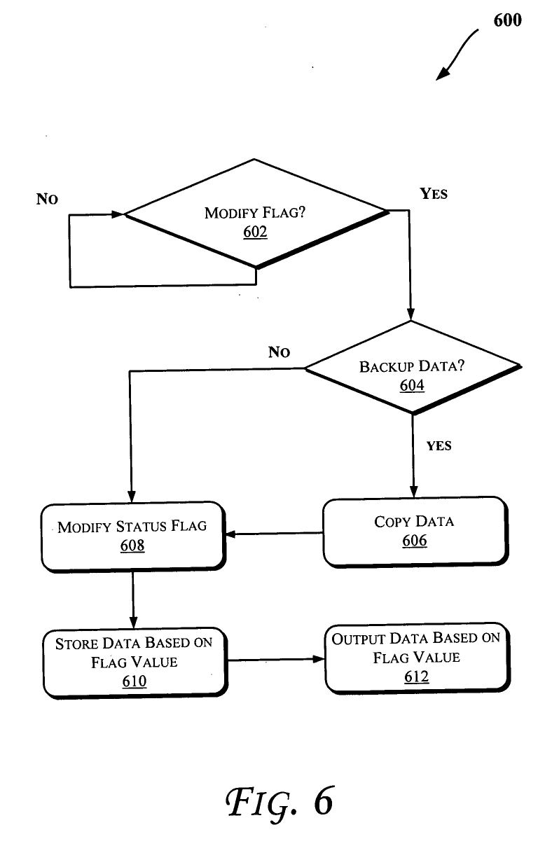

The core 106 may further include an inversion status flag 228 (which may be a single bit in an embodiment) and an inversion logic 226. In various embodiments, the inversion logic 226 may modify (e.g., invert) the value of the flag 228 and/or flags 224. In an embodiment, the memory 114 may include one or more inversion status flags 242 (which may include one or more bits that correspond to one or more portions of the memory 114 in an embodiment) and an inversion logic 240. In an embodiment, the inversion logic 240 may modify (e.g., invert) the value of the flag(s) 242. As will be further discussed herein, e.g., with reference to FIG. 6, the flags 224, 228, and/or 242 may be utilized to determine whether corresponding data stored in the registers 222, storage units of the core 106 (e.g., registers 222, cache 116, etc.), and/or memory 114, respectively, are to be modified prior to storage and/or outputting.

FIG. 3 illustrates a block diagram of portions of a cache 301, according to an embodiment of the invention. In one embodiment, the cache 301 may be the same as or similar to the cache 108 and/or 116 discussed with reference to FIGS. 1-2. As shown in FIG. 3, the cache 301 may include one or more cache lines 302. The cache 301 may also include one or more inversion status flags 304 for each of the cache lines 302, as will be further discussed with reference to FIG. 6. In one embodiment, a status flag 304 (which may be a bit in one embodiment) may be utilized to indicate whether data stored and/or read from the corresponding cache line (302) is to be inverted. In various embodiments, one or more status flags (304) may correspond to a portion of the cache 301 (e.g., a cache line, a cache block, etc.).

As illustrated in FIG. 3, the cache 301 may communicate via one or more of the interconnections 104 and/or 112 discussed with reference to FIG. 1 through a cache controller 306. The cache controller 306 may include logic for various operations performed on the cache 301. For example, the cache controller 306 may include an inversion logic 308, for example, to modify (e.g., invert) the value of one or more of the status flags 304. Alternatively, the logic 308 may be provided within other components of the processors 102 of FIG. 1.

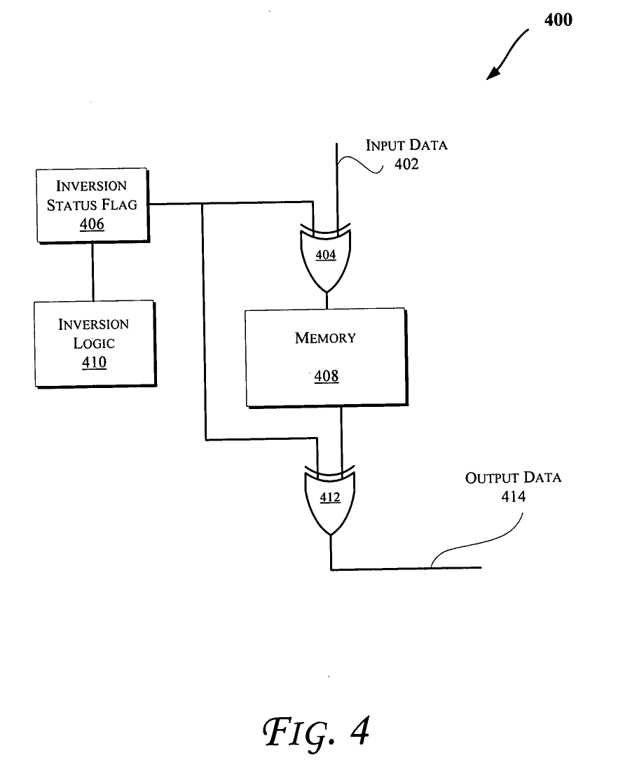

FIG. 4 illustrates a block diagram of a storage system 400, according to an embodiment. As shown in FIG. 4, input data 402 may be logically exclusive or-ed (e.g., by an XOR gate 404) with a value stored in an inversion status flag 406. Hence, depending on the value of the flag 406, an inverted or non-inverted version of the input data 402 may be stored in the memory 408. Furthermore, an inversion logic 410 may modify the value of the flag 406 as discussed, e.g., with reference to FIG. 6. The memory 408 may be the same or similar to the cache 108, cache 116, cache 301, and/or memory 114 of FIGS. 1-3 in various embodiments. Also, the flag 406 may be the same or similar to the flags 224, 228, 242, and/or 304 of FIGS. 1-3 in some embodiments. Additionally, the logic 410 may be the same or similar to the logics 226, 240, and/or 308 of FIGS. 1-3 in various embodiments.

As illustrated in FIG. 4, data read from the memory 408 may be logically exclusive or-ed (e.g., by an XOR gate 412) with the value stored in the inversion status flag 406. Hence, depending on the value of the flag 406, an inverted or non-inverted version of the stored data from the memory 408 may be provided as output data 414.

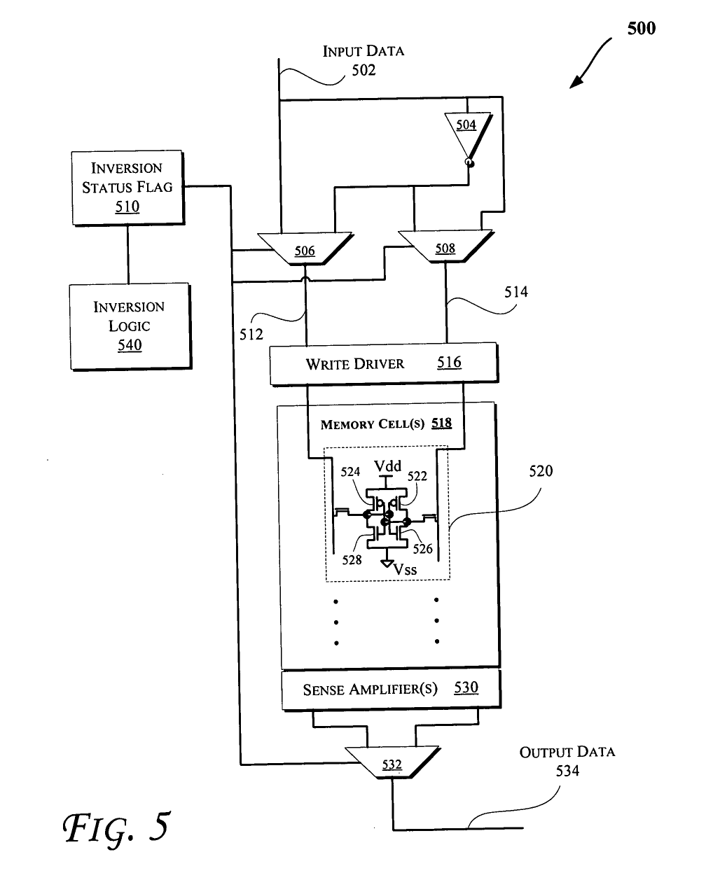

FIG. 5 illustrates a block diagram of a storage system 500, according to an embodiment. As shown in FIG. 5, input data 502 may be inverted (e.g., by an inverter 504). The inverted value of the input data (e.g., provided by the inverter 504) and the input data 502 may be provided to a pair of multiplexers 506 and 508 one of which may be selected based on the value stored in an inversion status flag 510. In one embodiment, the output of the multiplexers 506 and 508 may be complementary. Hence, depending on the value of the flag 510, an inverted or non-inverted version of the input data 502 may be passed (e.g., through the signals 512 and 514) to write driver 516 for storage in memory cell(s) 518. For example, if the flag 510 indicates that the input data 502 is to be modified, the output of the multiplexer 506 (512) may be a modified (e.g., inverted) version of the input data 502 and the output of the multiplexer 508 (514) may be the same as the input data 502.

The memory cell(s) 518 may have various configurations. In FIG. 5, a memory cell 520 is illustrated which may be utilized in accordance with one embodiment. The memory cell 520 may include at least two cross-coupled transistors to store an inverted and a non-inverted version of one bit of data. As shown in FIG. 5, a complementary MOS (CMOS) design may be used in accordance with one embodiment which may include four MOS transistors (e.g., including 2 p-channel MOS transistors 522 and 524, and 2 n-channel MOS transistors 526 and 528).

One or more sense amplifiers 530 may provide the inverted and non-inverted versions of the data stored in the memory cells 518 to a multiplexer 532, one of which may be selected based on the value stored in the inversion status flag 510 as output data 534. Furthermore, an inversion logic 540 may modify the value of the flag 510 as discussed, e.g., with reference to FIG. 6. The memory cells 518 may be the same or similar to the memory 408, cache 108, cache 116, cache 301, and/or memory 114 of FIGS. 1-4 in various embodiments. Also, the flag 510 may be the same or similar to the flags 224, 228, 242, 304, and/or 406 of FIGS. 1-4 in some embodiments. Additionally, the logic 540 may be the same or similar to the logics 226, 240, 308, and/or 410 of FIGS. 1-4 in various embodiments.

FIG. 6 illustrates a flow diagram of an embodiment of a method 600 to modify one or more bits of data stored in and/or read from a storage unit, in accordance with an embodiment of the invention. In an embodiment, various components discussed with reference to FIGS. 1-5 and 7-8 may be utilized to perform one or more of the operations discussed with reference to FIG. 6. For example, the method 600 may be used to modify data stored (and/or read) from a storage unit such as the cache 108, cache 116, memory 114, cache 301, memory 408, and/or memory cells 518.

Referring to FIGS. 1-6, at an operation 602, an inversion logic (e.g., one or more of the logics 226, 240, 308, 410, and/or 540) may determine if an inversion status flag (e.g., one or more of the flags 224, 242, 304, 406, and/or 510) is to be modified (e.g., inverted). For example, the value of the inversion status flag may be modified periodically (for example, by using a timer). Alternatively, the value of the inversion status flag may be modified after the corresponding portion of the storage unit (e.g., a portion of one or more of the cache 108, cache 116, memory 114, cache 301, memory 408, and/or memory cells 518) is deallocated, allocated (e.g., prior to storing new data in that portion of the storage unit), or otherwise after an indication that the data stored in the corresponding portion of the storage unit is to be replaced, invalidated, etc. (e.g., prior to storing new data in that portion of the storage unit). Further, the value of the status flag may be modified at system startup, after a reset (such as a hard reset or a soft reset). Also, for computing systems that are intended to be operational at all times (e.g., such as servers), the modification of the status flag may be forced e.g., on a periodical basis (for example, by using a timer) or by invoking a sleep cycle that causes the backup and restoration of the stored data, as will be further discussed with reference to operations 606 and 610.

If the flag is to be modified (602), at an operation 604, a storage unit controller (such as the cache controller 306, memory controller 710 of FIG. 7, and/or MCH 806 or 808 of FIG. 8) may determine whether data corresponding to the flag of operation 602 is to be backed up. For example, if the data corresponding to the flag of operation 602 is deallocate or about to be replaced, no back up may be necessary. Otherwise, at an operation 606, the data corresponding to the flag of operation 602 may be copied to a different storage unit or memory (such as those discussed with reference to FIGS. 1-5 and 7-8) at an operation 606. At an operation 608, the flag of operation 602 may be modified. After modification of the flag at operation 608, the data copied at operation 606 (or new data) may be stored at an operation 610 in accordance with the flag value. The stored data (610) may then be output in accordance with the modified flag value at operation 612. For example, as discussed with reference to FIGS. 4 and 5, inverted input data may be stored in a portion of a storage unit based on an inversion status value and an inverted version of the stored input data may be output from the storage unit based on the inversion status value.

FIG. 7 illustrates a block diagram of a computing system 700 in accordance with an embodiment of the invention. The computing system 700 may include one or more central processing unit(s) (CPUs) 702 or processors that communicate via an interconnection network (or bus) 704. The processors 702 may include a general purpose processor, a network processor (that processes data communicated over a computer network 703), or other types of a processor (including a reduced instruction set computer (RISC) processor or a complex instruction set computer (CISC)). Moreover, the processors 702 may have a single or multiple core design. The processors 702 with a multiple core design may integrate different types of processor cores on the same integrated circuit (IC) die. Also, the processors 702 with a multiple core design may be implemented as symmetrical or asymmetrical multiprocessors. In an embodiment, one or more of the processors 702 may be the same or similar to the processors 102 of FIG. 1. For example, one or more of the processors 702 may include one or more of the cores 106 and/or cache 108. Also, the operations discussed with reference to FIGS. 1-6 may be performed by one or more components of the system 700.

A chipset 706 may also communicate with the interconnection network 704. The chipset 706 may include a memory control hub (MCH) 708. The MCH 708 may include a memory controller 710 that communicates with the memory 114. The memory 114 may store data, including sequences of instructions that are executed by the CPU 702, or any other device included in the computing system 700. In one embodiment of the invention, the memory 114 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 704, such as multiple CPUs and/or multiple system memories.

The MCH 708 may also include a graphics interface 714 that communicates with a graphics accelerator 716. In one embodiment of the invention, the graphics interface 714 may communicate with the graphics accelerator 716 via an accelerated graphics port (AGP). In an embodiment of the invention, a display (such as a flat panel display) may communicate with the graphics interface 714 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 718 may allow the MCH 708 and an input/output control hub (ICH) 720 to communicate. The ICH 720 may provide an interface to I/O devices that communicate with the computing system 700. The ICH 720 may communicate with a bus 722 through a peripheral bridge (or controller) 724, such as a peripheral component interconnect (PCI) bridge, a universal serial bus (USB) controller, or other types of peripheral bridges or controllers. The bridge 724 may provide a data path between the CPU 702 and peripheral devices. Other types of topologies may be utilized. Also, multiple buses may communicate with the ICH 720, e.g., through multiple bridges or controllers. Moreover, other peripherals in communication with the ICH 720 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 722 may communicate with an audio device 726, one or more disk drive(s) 728, and a network interface device 730 (which is in communication with the computer network 703). Other devices may communicate via the bus 722. Also, various components (such as the network interface device 730) may communicate with the MCH 708 in some embodiments of the invention. In addition, the processor 702 and the MCH 708 may be combined to form a single chip. Furthermore, the graphics accelerator 716 may be included within the MCH 708 in other embodiments of the invention.

Furthermore, the computing system 700 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 728), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 8 illustrates a computing system 800 that is arranged in a point-to-point (PtP) configuration, according to an embodiment of the invention. In particular, FIG. 8 shows a system where processors, memory, and input/output devices are interconnected by a number of point-to-point interfaces. The operations discussed with reference to FIGS. 1-7 may be performed by one or more components of the system 800.

As illustrated in FIG. 8, the system 800 may include several processors, of which only two, processors 802 and 804 are shown for clarity. The processors 802 and 804 may each include a local memory controller hub (MCH) 806 and 808 to enable communication with memories 810 and 812. The memories 810 and/or 812 may store various data such as those discussed with reference to the memory 114 of FIG. 7.

In an embodiment, the processors 802 and 804 may be one of the processors 702 discussed with reference to FIG. 7. The processors 802 and 804 may exchange data via a point-to-point (PtP) interface 814 using PtP interface circuits 816 and 818, respectively. Also, the processors 802 and 804 may each exchange data with a chipset 820 via individual PtP interfaces 822 and 824 using point-to-point interface circuits 826, 828, 830, and 832. The chipset 820 may further exchange data with a high-performance graphics circuit 834 via a high-performance graphics interface 836, e.g., using a PtP interface circuit 837.

At least one embodiment of the invention may be provided within the processors 802 and 804. For example, one or more of the cores 106 and/or cache 108 of FIG. 1 may be located within the processors 802 and 804. Other embodiments of the invention, however, may exist in other circuits, logic units, or devices within the system 800 of FIG. 8. Furthermore, other embodiments of the invention may be distributed throughout several circuits, logic units, or devices illustrated in FIG. 8.

The chipset 820 may communicate with a bus 840 using a PtP interface circuit 841. The bus 840 may have one or more devices that communicate with it, such as a bus bridge 842 and I/O devices 843. Via a bus 844, the bus bridge 843 may communicate with other devices such as a keyboard/mouse 845, communication devices 846 (such as modems, network interface devices, or other communication devices that may communicate with the computer network 703), audio I/O device, and/or a data storage device 848. The data storage device 848 may store code 849 that may be executed by the processors 802 and/or 804.

In various embodiments of the invention, the operations discussed herein, e.g., with reference to FIGS. 1-8, may be implemented as hardware (e.g., circuitry), software, firmware, microcode, or combinations thereof, which may be provided as a computer program product, e.g., including a machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-8. Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first logic to cause storage of a modified version of one or more bits of data in a storage unit during a first time period.

2. The apparatus of claim 1, wherein the modified version of the one or more bits of data is an inverted version of the one or more bits of data.

3. The apparatus of claim 1, further comprising a second logic to cause output of a modified version of the stored data from the storage unit during the first time period.

4. The apparatus of claim 3, wherein the modified version of the stored data is an inverted version of the stored data.

5. The apparatus of claim 1, further comprising a second logic to modify a value of a flag to indicate an occurrence of the first time period or an occurrence of a second time period.

6. The apparatus of claim 5, wherein the second logic modifies the value of the flag periodically.

7. The apparatus of claim 5, wherein the modification of the flag value at least partially reduces an aging effect on one or more portions of the storage unit.

8. The apparatus of claim 1, further comprising a second logic to invert the one or more bits of data prior to the storage of the one or more bits of data in the storage unit.

9. The apparatus of claim 1, wherein the storage unit comprises at least two transistors to store a bit of the data.

10. The apparatus of claim 1, further comprising one or more processor cores to access the storage unit.

11. The apparatus of claim 10, wherein at least one of the one or more processor cores and the first logic are on a same die.

12. The apparatus of claim 1, wherein the storage unit comprises a portion of one or more of a cache, a register, or a dynamic random access memory device.

13. The apparatus of claim 12, further comprising a plurality of flags, wherein each of the plurality of flags corresponds to one or more of a portion of the cache, a portion of the register, or a portion of the dynamic random access memory device.

14. The apparatus of claim 13, wherein the portion of the cache comprises one or more of a cache line or a cache block.

15. A method comprising:
storing inverted input data in a portion of a storage unit based on an inversion status value; and
outputting an inverted version of the stored input data from the storage unit based on the inversion status value.

16. The method of claim 15, further comprising modifying the inversion status value periodically.

17. The method of claim 15, further comprising modifying the inversion status value after the portion of the storage unit is deallocated.

18. The method of claim 15, further comprising modifying the inversion status value after the portion of the storage unit is allocated and prior to storing the inverted input data in the storage unit.

19. The method of claim 15, further comprising copying data stored in the portion of the storage unit to a memory prior to modifying the inversion status value.

20. The method of claim 19, further comprising restoring data from the memory to the portion of the storage unit after modifying the inversion status value.

21. A system comprising:
a memory to store data;
a first logic to cause modification of data that is to be stored in a first portion of the memory; and
a second logic to cause modification of data that is to be read from the first portion of the memory in accordance with an indicia.

22. The system of claim 21, further comprising a third logic to modify a value of the indicia periodically.

23. The system of claim 21, wherein the memory comprises a cache.

24. The system of claim 23, wherein the indicia corresponds to a portion of the cache.

25. The system of claim 24, wherein the portion of the cache is one or more of a cache line or a cache block.

26. The system of claim 21, wherein the memory comprises a plurality of p-channel metal-oxide semiconductor (P-MOS) or n-channel metal-oxide semiconductor (N-MOS) transistors.

27. The system of claim 21, further comprising a plurality of processor cores to access the data stored in the memory.

28. The system of claim 27, wherein at least one of the plurality of processor cores and the first logic are on a same die.

29. The system of claim 21, further comprising a third logic to modify a value of the indicia after an indication that data stored in the first portion of the memory is to be replaced and prior to storing new data in the first portion of the memory.

30. The system of claim 21, further comprising an audio device.
